(19) United States
(12) Patent Application Publication
(10) Pub. No.: US 2026/0341561 A1
(43) Pub. Date: Oct. 29, 2026

(54) SOFT MAGNETIC METAL POWDER HAVING HIGH SPHEROIDIZATION RATE AND METHOD FOR MANUFACTURING SAME

(71) Applicant: TODA KOGYO CORP., Hiroshima-shi (JP)

(72) Inventors: Seiji ISHITANI, Otake-shi (JP); Takumi IZAWA, Otake-shi (JP); Shinji HORIE, Otake-shi (JP)

(73) Assignee: TODA KOGYO CORP., Hiroshima-shi (JP)

(21) Appl. No.: 19/106,396

(22) PCT Filed: Aug. 28, 2023
(86) PCT No.: PCT/JP2023/030904

§ 371 Date: Jun. 24, 2025

(30) Foreign Application Priority Data
Sep. 1, 2022 (JP) 2022-139415

(51) Int. Cl. H01F 1/147; B22F 1/05; B22F 1/065; B22F 1/14

(52) U.S. Cl. CPC H01F 1/147; B22F 1/05; B22F 1/065; B22F 1/14

(57) ABSTRACT

A soft magnetic metal powder has an average particle size of 0.05 μm or more and 1.5 μm or less, a coefficient of variation expressed by the following (expression 1) of 0.25 or less, a boron content of less than 1.5% by weight (excluding 0), and a spheroidization ratio expressed by the following (expression 2) of 75% or more: (expression 1) standard deviation of particle size/average particle size; (expression 2) (area/area of smallest circumcircle)×100.

### TECHNICAL FIELD

The present invention relates to a soft magnetic metal powder. Specifically, the soft magnetic metal powder relates to a soft magnetic metal powder that is a collection of fine particles, that has a high spheroidization ratio and can thus be used to prepare a paste having low viscosity from which a thin layer can be easily formed, that has a low content of boron, which decreases saturation magnetization, and can thus be used to fabricate an electronic component having excellent magnetic characteristics, and that has a narrow particle size distribution and thus has high dispersibility in solvent and can be used to form a thin layer having excellent surface smoothness.

### BACKGROUND ART

There is a need for a soft magnetic metal powder with higher density for use as an inductor or transformer core material to achieve improved magnetic characteristics.

In addition, the need for thinner electronic components has led to the development of thinner inductors and transformers.

Typical examples of methods for manufacturing soft magnetic metal powders include a water atomization method, a gas atomization method, and a spray pyrolysis method. Soft magnetic metal powders manufactured by these methods have broad particle size distributions.

A broad particle size distribution causes a problem in that it is difficult to achieve good surface smoothness when forming a thin layer.

As in PTL 1 described later, a fine soft magnetic metal powder can be prepared by a liquid-phase reduction method in which a metal salt aqueous solution is reduced with a boron (B)-based reductant. However, the use of a B-based reductant causes a problem in that the magnetic characteristics deteriorate due to the effect of B.

Accordingly, it has been desirable to develop a soft magnetic metal powder that has a narrow particle size distribution and can thus be used to form a thin layer having excellent surface smoothness and that has a low B content and can thus be used to fabricate an electronic component having excellent magnetic characteristics.

### CITATION LIST

### Patent Literature

PTL 1: Japanese Unexamined Patent Application Publication No. 2010-261065

### Non Patent Literature

NPL 1: Materials Chemistry and Physics 123(2010) 487-493

### SUMMARY OF INVENTION

### Technical Problem

PTL 1 describes a method for preparing a soft magnetic metal powder having a smaller particle size than conventional soft magnetic metal powders by a liquid-phase reduction method in which a reductant solution containing a B-based reductant is added dropwise to an iron salt aqueous solution containing an iron salt, a complexing agent, a dispersant, a pH adjuster, and a P-based reductant.

However, the liquid-phase reduction method described in PTL 1 has a problem in that, when the amount of B is reduced to improve the magnetization characteristics, the resulting powder is composed of single-phase α-Fe particles that have a low spheroidization ratio because of their crystal structure, which leads to a low packing factor of a coating film and thus makes it impossible to obtain a smooth thin layer.

NPL 1 discloses the use of a polyol method as a method for synthesizing an α-Fe particle powder.

However, the method of manufacture described in NPL 1 has a problem in that the resulting powder is a collection of particles having a low spheroidization ratio and a broad particle size distribution, which makes it impossible to obtain a thin layer having excellent surface smoothness.

After conducting trial manufacture and experimentation many times by trial and error in order to solve the above various problems, which is a technical object, the inventors have successfully prepared a soft magnetic metal powder having an average particle size of 0.05 μm or more and 1.5 μm or less, a coefficient of variation expressed by [standard deviation of particle size/average particle size] of 0.25 or less, a B content of less than 1.5% by weight (excluding 0), and a spheroidization ratio expressed by [(area/area of smallest circumcircle)×100] of 75% or more, thus achieving the above technical object.

A soft magnetic metal powder according to the present invention is composed of fine particles having a small average particle size and a high spheroidization ratio and can thus be used to prepare a paste having low viscosity from which a thin layer can be easily formed. In addition, the soft magnetic metal powder has a low content of B, which decreases saturation magnetization, and can thus be used to fabricate an electronic component having excellent magnetic characteristics since a deterioration in magnetic characteristics due to B can be reduced. Furthermore, the soft magnetic metal powder has a narrow particle size distribution and thus has high dispersibility in solvent and can be used to form a thin layer having excellent surface smoothness.

### Solution to Problem

The above technical object can be achieved by the present invention as follows.

The present invention is a soft magnetic metal powder having an average particle size of 0.05 μm or more and 1.5 μm or less, a coefficient of variation expressed by the following (expression 1) of 0.25 or less, a boron content of less than 1.5% by weight (excluding 0), and a spheroidization ratio expressed by the following (expression 2) of 75% or more:

standard deviation of particle size/average particle size (expression 1)

(area/area of smallest circumcircle)×100 (expression 2)

The present invention is also the soft magnetic metal powder, wherein the soft magnetic metal powder has an oxygen content of 3.0% by weight or less.

The present invention is also the soft magnetic metal powder, wherein the soft magnetic metal powder has an iron content of 93% by weight or more.

The present invention is also the soft magnetic metal powder, wherein the soft magnetic metal powder is coated with one or more metal oxides.

The present invention is also the soft magnetic metal powder, wherein metal elements of the metal oxides are each aluminum, silicon, zirconium, titanium, yttrium, or phosphorus.

The present invention is also a method for manufacturing the soft magnetic metal powder, including subjecting to spheroidization treatment a soft magnetic metal powder manufactured by a liquid-phase reduction method in which a reductant containing a boron-based reductant is added dropwise to a metal salt aqueous solution containing a metal salt, a complexing agent, a pH adjuster, and a phosphorus-based reductant.

The present invention is also the method for manufacturing the soft magnetic metal powder, wherein the soft magnetic metal powder is spheroidized by mechanochemical treatment.

### Advantageous Effects of Invention

Because the present invention is a soft magnetic metal powder that is a collection of fine particles, namely, particles having an average particle size of 0.05 μm to 1.5 μm, the packing factor and dispersibility of the soft magnetic metal powder in a solvent such as a resin are improved, and the powder can thus be used to fabricate an electronic component having superior magnetic characteristics.

In addition, because the soft magnetic metal powder is a collection of fine particles having a narrow particle size distribution, namely, a coefficient of variation expressed by (expression 1) of 0.25 or less, the soft magnetic metal powder has high dispersibility in solvent and can thus be used to form a thin layer having excellent surface smoothness.

In addition, because the soft magnetic metal powder has a content of B, which decreases saturation magnetization, of less than 1.5% by weight (excluding 0), the soft magnetic metal powder can be used to fabricate an electronic component having excellent magnetic characteristics since a deterioration in magnetic characteristics due to B can be reduced.

In addition, because the soft magnetic metal powder has a high spheroidization ratio expressed by (expression 2), namely, 75% or more, the packing factor and dispersibility of the soft magnetic metal powder in a solvent such as a resin are improved, and the powder can thus be used to prepare a paste having low viscosity from which a thin layer can be easily formed. The resulting thin layer has excellent surface smoothness.

In addition, when the soft magnetic metal powder has an oxygen (O) content of 3.0% by weight or less, a decrease in saturation magnetization due to an oxide film can be reduced.

In addition, when the soft magnetic metal powder has an iron (Fe) content of 93% by weight or more, the soft magnetic metal powder can be used to fabricate an electronic component having high saturation magnetization.

In addition, when the soft magnetic metal powder is coated with one or more metal oxides, it is possible to ensure electrical insulation between the particles and thus reduce energy loss.

In addition, the soft magnetic metal powder of the present invention can be prepared by a simple method in which a soft magnetic metal powder is prepared by a liquid-phase reduction method using a B-based reductant and is then subjected to spheroidization treatment.

In addition, when the soft magnetic metal powder is spheroidized by mechanochemical treatment, a soft magnetic metal powder having a high spheroidization ratio can be prepared.

### BRIEF DESCRIPTION OF DRAWINGS

FIG. 1 is a SEM photograph (50,000 times) of a soft magnetic metal powder of Example 1.

FIG. 2 is a SEM photograph (50,000 times) of a soft magnetic metal powder of Comparative Example 1.

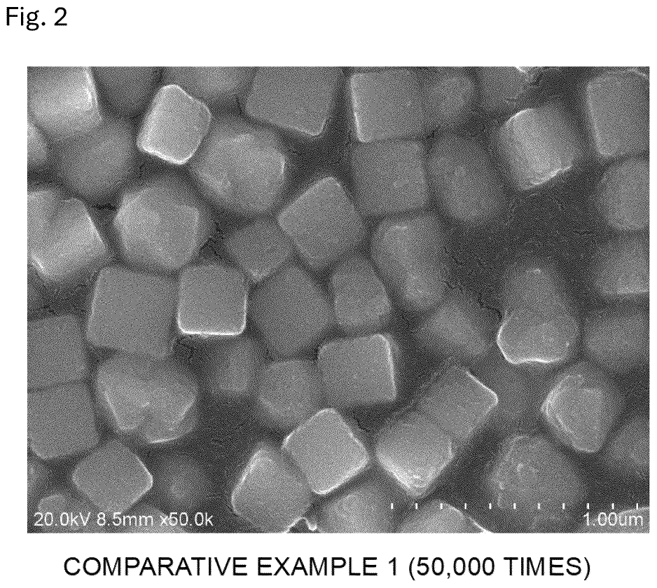

### DESCRIPTION OF EMBODIMENTS

A soft magnetic metal powder of the present invention is composed of fine particles, has a high spheroidization ratio, and has a low content of boron, which decreases saturation magnetization, and can thus be used to fabricate an electronic component having excellent magnetic characteristics. In addition, the soft magnetic metal powder has a narrow particle size distribution and thus has high dispersibility in solvent and can be used to form a thin layer having excellent surface smoothness.

The soft magnetic metal powder of the present invention preferably has an average particle size of 0.05 μm to 1.5 μm, more preferably 0.07 μm to 1.0 μm, even more preferably 0.1 μm to 0.8 μm.

This is because when the soft magnetic metal powder has an average particle size of less than 0.05 μm, the saturation magnetization may decrease due to an increased proportion of an oxide film on the surface of the particles, whereas when the soft magnetic metal powder has an average particle size of more than 1.5 μm, the surface smoothness of a thin layer may decrease due to an increased maximum height (Rmax) value.

The average particle size can be calculated by capturing an image under a scanning electron microscope (SEM) at a magnification of 2000 times to 10000 times, measuring the longest diameters of all particles in the field of view of the image using image analysis software, and calculating the average thereof.

The soft magnetic metal powder of the present invention preferably has a coefficient of variation of 0.25 or less, more preferably 0.24 or less, even more preferably 0.22 or less.

This is because when the soft magnetic metal powder has a coefficient of variation of more than 0.25, the surface smoothness of a thin layer may decrease due to an increased Rmax value.

The coefficient of variation can be calculated by using the following (expression 1).

standard deviation of particle size/average particle size (Expression 1)

The lower limit value of the coefficient of variation is about 0.001.

The soft magnetic metal powder of the present invention preferably has a spheroidization ratio of 75% or more, more preferably 78% or more, even more preferably 79% or more.

This is because a higher spheroidization ratio tends to result in a lower viscosity of a paste prepared by dispersing the powder in a solvent such as a resin and tends to result in a lower Rmax value of the surface of a thin layer.

When the soft magnetic metal powder has a spheroidization ratio of less than 75%, the viscosity of a paste prepared by dispersing the powder in a resin increases, and the Rmax value of the surface of a thin layer increases.

The spheroidization ratio can be calculated by capturing an image under a scanning electron microscope (SEM) at a magnification of 2000 times to 10000 times, measuring the areas and the areas of the smallest circumcircles of all particles in the field of view of the image using image analysis software, and calculating the spheroidization ratio by using the following (expression 2).

(area/area of smallest circumcircle)×100) (Expression 2)

The soft magnetic metal powder of the present invention preferably has an iron (Fe) content of 93% by weight or more, more preferably 95% by weight or more, even more preferably 96% by weight or more.

When the soft magnetic metal powder has an Fe content of 93% by weight or more, an electronic component having high saturation magnetization can be fabricated.

The soft magnetic metal powder of the present invention has a B content of less than 1.5% by weight, although the B content is not 0% by weight.

This is because whereas a lower B content is preferred since B decreases saturation magnetization, a soft magnetic metal powder fabricated by a liquid-phase reduction method without using a B-based reductant contains an increased amount of fine particles having a low spheroidization ratio and still contains a large amount of fine particles having a low spheroidization ratio after spheroidization treatment, which may worsen the viscosity of a paste prepared therefrom and the surface smoothness of a thin layer.

To reduce a decrease in saturation magnetization due to an oxide film, the soft magnetic metal powder preferably has an O content of 3.0% by weight or less, more preferably 2.5% by weight or less, even more preferably 2.3% by weight or less.

In addition, the lower limit of the O content of the soft magnetic metal powder is 0.05% by weight.

The soft magnetic metal powder of the present invention may be coated with one or more metal oxides. This is because an improved insulation effect can be expected.

Examples of metal elements contained in the metal oxides include aluminum (Al), silicon (Si), zirconium (Zr), titanium (Ti), yttrium (Y), and phosphorus (P).

The metal oxides preferably have a metal element content of 0.1% by weight to 3.0% by weight.

This is because when the metal oxides have a metal element content of less than 0.1% by weight, it may be impossible to achieve a sufficient insulation effect, whereas when the metal oxides have a metal element content of more than 3.0% by weight, the saturation magnetization may decrease.

The soft magnetic metal powder of the present invention may contain P, although the soft magnetic metal powder need not necessarily contain P.

The soft magnetic metal powder of the present invention preferably has a P content of 2.0% by weight or less, more preferably 1.0% by weight or less, even more preferably 0.5% by weight or less.

When the soft magnetic metal powder has a P content of more than 2.0% by weight, it may be impossible to achieve sufficient magnetic characteristics since the saturation magnetization decreases due to an increased proportion of nonmagnetic components.

A paste that is a dispersion containing the soft magnetic metal powder of the present invention preferably has a viscosity of 50 Pa·s or less, more preferably 45 Pa·s or less.

A thin layer (thickness: 10 μm to 30 μm) formed from the soft magnetic metal powder paste of the present invention preferably has a maximum height (Rmax) of less than 3.5 μm, more preferably 3.0 μm or less.

When the thin layer (thickness: 10 μm to 30 μm) formed from the soft magnetic metal powder paste has a maximum height (Rmax) of 3.5 μm or more, it is difficult to maintain the surface smoothness of the thin layer.

To fabricate an electronic component having sufficient magnetic characteristics, the soft magnetic metal powder preferably has a saturation magnetization of 190 Wb·m/kg or more and a coercive force of 10 kA/m or less.

This is because when the soft magnetic metal powder has a coercive force of more than 10 kA/m, it may be impossible to achieve sufficient magnetic characteristics.

The present invention can be prepared by a liquid-phase reduction method in which a metal salt aqueous solution is reduced with a B-based reductant.

The metal salt is preferably, but not limited to, an iron salt.

Examples of iron salts include, but not limited to, iron (II) sulfate, iron (II) chloride, iron (II) acetate, iron (II) oxalate, iron (III) chloride, and iron (III) sulfate.

A complexing agent may be added to the metal salt aqueous solution, and a reductant that are not B-based may also be added.

Examples of complexing agents include, but not particularly limited to, glycine, alanine, ammonium sulfate, ammonium chloride, and trisodium citrate.

Examples of reductants that can be used include, but not particularly limited to, P-based reductants.

Examples of P-based reductants include sodium hypophosphite and calcium hypophosphite.

The pH of the metal salt aqueous solution is preferably adjusted to 6.5 to 11.0 with a pH adjuster.

Examples of pH adjusters include, but not particularly limited to, sodium hydroxide, aqueous ammonia, and sodium hydrogen carbonate.

A dispersant, a catalyst, and a defoamer may be added as appropriate to the metal salt aqueous solution.

A B-based reductant is used as a reductant for reducing the metal salt aqueous solution.

Examples of B-based reductants include, but not particularly limited to, sodium borohydride, potassium borohydride, and dimethylaminoborane.

Hydrazine, which does not contain B, may be used in combination with the B-based reductant.

The reduction temperature is preferably 50 °C to 95 °C.

This is because when the reduction temperature is lower than 50 °C, a single-phase α-Fe particle powder is not obtained due to an increased amount of B, whereas when the reduction temperature is higher than 95 °C, it is difficult to obtain the intended soft magnetic metal powder due to accelerated deactivation of the reductant.

In the present invention, spheroidization treatment may be performed to obtain a soft magnetic metal powder having the desired spheroidization ratio.

An increase in the spheroidization ratio of the soft magnetic metal powder results in an improvement in packing factor in a solvent such as a resin, which improves the magnetic characteristics such as magnetic permeability and allows the core loss to be reduced.

Examples of methods for spheroidization treatment include, but not particularly limited to, mechanochemical treatment, in which a stress such as consolidation, shear, or compression can be applied to particles.

The mechanochemical treatment in the present invention can be performed using a mechanical pulverizer.

Examples of mechanical pulverizers include bead mills, rocking mills, jet mills, tower mills, ball mills such as planetary mills, tumbling mills, and vibrating mills, mechanofusion, hybridizers, Henschel mixers, and homo-mixers.

The mechanochemical treatment time is preferably 30 minutes to 180 minutes.

### EXAMPLES

Examples of the present invention are shown below, although the present invention is not limited to these examples.

### Example 1

Iron (II) sulfate heptahydrate, serving as an iron salt, glycine, serving as a complexing agent, and sodium hypophosphite, serving as a P-based reductant, were fed into a glass beaker together with 1500 ml of distilled water in concentrations of 0.10 mol/l, 0.10 mol/l, and 0.08 mol/l, respectively. Sodium hydroxide was used as a pH adjuster at room temperature with stirring using a stirrer at 100 rpm to 300 rpm to prepare a metal salt aqueous solution with a pH of 7.0 to 8.5.

Sodium borohydride, serving as a B-based reductant, was mixed with 300 ml of distilled water in a concentration of 0.28 mol/l and was dissolved at room temperature with stirring using a stirrer at 100 rpm to 300 rpm to prepare a B-based reductant solution.

The metal salt aqueous solution was heated in a nitrogen atmosphere with stirring using a stirrer at 100 rpm to 300 rpm, and the B-based reductant solution was added dropwise thereto. The reduction temperature was 68 °C.

After the dropwise addition of the B-based reductant solution was completed, the point in time when there was no bubbling in the metal salt aqueous solution was determined to be the endpoint of the reduction reaction.

After the completion of the reduction reaction, the reaction product was rinsed with distilled water, followed by replacement with an alcohol and drying in an inert atmosphere to obtain a soft magnetic metal powder.

The resulting soft magnetic metal powder was a single-phase α-Fe powder having a spheroidization ratio of 68.6%.

This soft magnetic metal powder was subjected to mechanochemical treatment in which shear force and compression force were applied to the particles for 120 minutes.

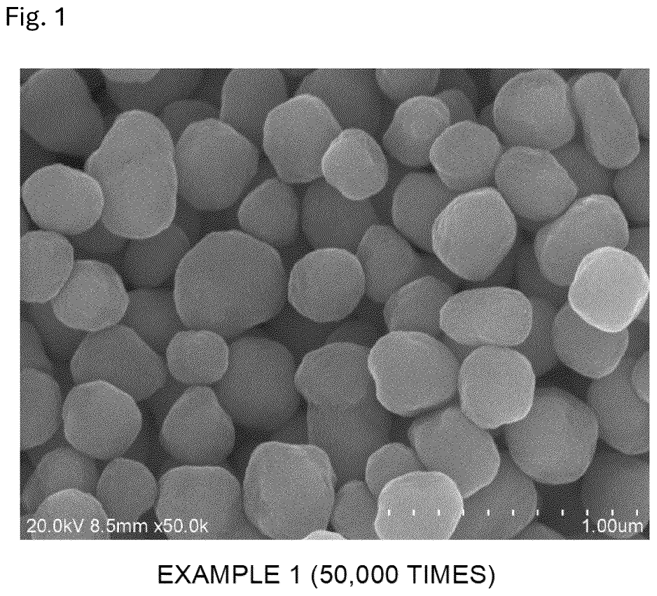

The soft magnetic metal powder of Example 1 subjected to mechanochemical treatment had a spheroidization ratio of 80.2% (FIG. 1).

### Examples 2 and 3 and Comparative Examples 1 and 2

Soft magnetic metal powders were obtained under the same manufacture conditions as in Example 1 except that the type and amount of iron salt added, the type and amount of complexing agent added, the types and amounts of reductants added, the type of pH adjuster, the reduction temperature, and the presence or absence and time of the mechanochemical treatment were changed as shown in Table 1.

### Example 4

The soft magnetic metal powder obtained in Example 1, tetraethoxysilane (TEOS), and aqueous ammonia were fed into a glass beaker together with 150 ml of isopropyl alcohol in concentrations of 0.30 mol/l, 0.04 mol/l, and 0.20 mol/l, respectively. TEOS was hydrolyzed at room temperature with stirring using a stirrer at 100 rpm to 300 rpm over one hour to obtain a silica-coated soft magnetic metal powder.

The silica-coated soft magnetic metal powder was rinsed with isopropyl alcohol, followed by drying in a nitrogen atmosphere to obtain a silica-coated soft magnetic metal powder.

### Comparative Example 3

An α-Fe particle powder was synthesized by the polyol method disclosed in NPL 1.

Specifically, 100 ml of ethylene glycol was placed in a glass container equipped with a reflux condenser and was stirred with a Teflon (registered trademark) stirring impeller at a rotational speed of 100 rpm while nitrogen gas was injected at a flow rate of 300 ml/min.

Ferrous chloride tetrahydrate (FeCl₂·4H₂O) was fed into the liquid being stirred in a concentration of 0.1 mol/l.

NaOH was then fed in a concentration ratio ([OH⁻]/[Fe]) of [OH⁻] to [Fe] of 40.

Hexachloroplatinic (IV) acid, serving as a platinum precursor for nucleation, was then fed in a concentration of 2.0×10⁻⁸ mol/l.

After the above materials were fed, cooling water was allowed to flow through the reflux condenser, and a reduction reaction was performed by heating the mixture while continuing the injection of nitrogen gas and mechanical stirring and holding the mixture at 170 °C. under reflux for 20 minutes.

After the solution was allowed to cool to room temperature, the precipitated particles were transferred into ethanol and were repeatedly cleaned by centrifugal separation, followed by drying in a nitrogen atmosphere to obtain an α-Fe particle powder.

### Comparative Example 4

A carbonyl iron powder (HQ, manufactured by BASF) was used.

(Average Particle Size (D), Standard Deviation (o) of Particle Size, Coefficient of Variation (o/D), and Spheroidization Ratio)

An image was captured under a scanning electron microscope (SEM) (S-4800 type FE-SEM, manufactured by Hitachi High-Tech Corporation) at 2000 times to 10000 times.

The longest diameters of all particles in the field of view of the captured image were measured using the image analysis software A-Zou Kun (manufactured by Asahi Kasei Engineering Corporation).

The measured size data was used to calculate the average particle size, the standard deviation of the particle size, the coefficient of variation, and the spheroidization ratio.

### (Crystal Structure)

A measurement was performed using an X-ray diffractometer (D8 ADVANCE, manufactured by Bruker Japan K. K.), and the crystal phase in the sample was determined by Rietveld analysis.

### (Compositional Analysis [Fe, P, Si])

A measurement was performed using a fluorescent X-ray diffractometer (ZSX Primus II, manufactured by Rigaku Corporation) in accordance with JIS K 0119 “General rules for X-ray fluorescence analysis”.

### (Compositional Analysis [B])

A measurement was performed using an inductively coupled plasma (ICP) spectrometer (iCAP 6500, manufactured by Thermo Fisher Scientific Inc.).

### (Compositional Analysis [O])

A measurement was performed using an oxygen/nitrogen/hydrogen analyzer (EMGA-930, manufactured by Horiba, Ltd.).

### (Magnetic Characteristics)

Saturation magnetization (σs) and coercive force (Hc) were measured using a vibrating sample magnetometer (VSM) (TM-VSM2130 MRHL type, manufactured by Tamagawa Co., Ltd.) at an applied magnetic field of 797.7 kA/m.

### (Viscosity Characteristics)

To 5.0 g of each of the soft magnetic metal powders of the Examples and the Comparative Examples were added 0.5 ml of castor oil and 3.2 g of a clear lacquer. The mixture was stirred using a rotating/orbiting mixer (Awatori Rentaro ARE-310, manufactured by Thinky Corporation) at 1500 rpm for 3 minutes to prepare a paste.

The viscosity of the resulting paste was measured using an E-type viscometer (TVE-35 Type H, H3°×R9.7 cone, manufactured by Toki Sangyo Co., Ltd.) at 25 °C and a rotational speed of 20 rpm.

### (Maximum Height Rmax of Thin Layer)

To 5.0 g of each of the soft magnetic metal powders of the Examples and the Comparative Examples were added 0.5 ml of castor oil and 3.2 g of a clear lacquer. The mixture was stirred using a rotating/orbiting mixer at 1500 rpm for 3 minutes to prepare a paste.

The resulting paste was applied to a PET film using a 3-mil applicator and was dried at room temperature to form a thin layer (coating film) having a thickness of about 20 μm.

The maximum height Rmax of the thin layer was measured using a non-contact surface roughness tester (NewView 600, manufactured by Canon Marketing Japan Inc.).

The materials and conditions used for the Examples and the Comparative Examples are shown in Table 1, and the results are shown in Table 2.

TABLE 1

| | | Iron salt | | Complexing agent 1 | | Complexing agent 2 | | Reductant 1 | |
|---|---|---|---|---|---|---|---|---|---|
| | | | Amount | | Amount | | Amount | | Amount |
| | | | Added | | Added | | Added | | Added |
| | | Type | (mol/l) | Type | (mol/l) | Type | (mol/l) | Type | (mol/l) |
| Ex. | 1 | Iron(II) | 0.10 | Glycine | 0.10 | — | — | Sodium | 0.28 |
| | | sulfate | | | | | | borohydride | |
| | 2 | Iron(II) | 0.10 | Glycine | 0.15 | Ammonium | 0.10 | Sodium | 0.30 |
| | | chloride | | | | sulfate | | borohydride | |
| | 3 | Iron(II) | 0.10 | Glycine | 0.10 | — | — | Sodium | 0.20 |
| | | sulfate | | | | | | borohydride | |
| Comp. | 1 | Iron(II) | 0.10 | Glycine | 0.10 | — | — | Sodium | 0.28 |
| Ex. | | sulfate | | | | | | borohydride | |
| | 2 | Iron(II) | 0.20 | Glycine | 0.08 | — | — | Sodium | 0.30 |
| | | sulfate | | | | | | borohydride | |

| | | | | | | Mechanochemical | |
|---|---|---|---|---|---|---|---|
| | | Reductant 2 | | | Reduction | treatment | |
| | | | Amount | | reaction | Presence or | Treatment |
| | | | Added | pH adjuster | Temperature | absence of | time |
| | | Type | (mol/l) | Type | (°C) | treatment | (min.) |
| Ex. | 1 | Sodium | 0.08 | Sodium hydroxide | 68 | Present | 120 |
| | | hypophosphite | | | | | |
| | 2 | Sodium | 0.15 | Sodium hydroxide + | 75 | Present | 180 |
| | | hypophosphite | | ammonia | | | |
| | 3 | — | — | Sodium hydroxide | 68 | Present | 60 |
| Comp. | 1 | Sodium | 0.08 | Sodium hydroxide | 68 | Absent | — |
| Ex. | | hypophosphite | | | | | |
| | 2 | Sodium | 0.10 | Sodium hydroxide | 42 | Absent | — |
| | | hypophosphite | | | | | |

TABLE 2

| | | Particle properties | | | | | | | | | | Viscosity | |
|---|---|---|---|---|---|---|---|---|---|---|---|---|---|
| | | Average | | Spheroidiza- | | | | | | Powder characteristics | | evaluation | Film |
| | | particle | | tion | Compositional analysis results | | | | | Saturation | Coercive | Paste | characteristics |
| | | size | σ/ | ratio | Fe | B | P | Si | O | magnetization | force | viscosity | Rmax |
| | | (μm) | D | (%) | (wt %) | (wt %) | (wt %) | (wt %) | (wt %) | (Wb · m/kg) | (kA/m) | (Pa · s) | (μm) |
| Ex. | 1 | 0.38 | 0.15 | 80.2 | 97.6 | 0.4 | 0.1 | — | 1.9 | 198 | 2.36 | 34.3 | 2.8 |
| | 2 | 0.79 | 0.24 | 79.5 | 96.7 | 1.3 | 0.1 | — | 1.9 | 201 | 1.95 | 29.7 | 3.4 |
| | 3 | 0.12 | 0.13 | 75.2 | 97.5 | 0.2 | — | — | 2.3 | 191 | 9.53 | 44.1 | 3.0 |
| | 4 | 0.39 | 0.15 | 80.4 | 96.4 | 0.5 | 0.1 | 1.0 | 2.0 | 198 | 2.37 | 35.2 | 2.7 |
| Comp. | 1 | 0.38 | 0.16 | 68.6 | 96.6 | 0.4 | 0.1 | — | 2.9 | 198 | 2.85 | 49.7 | 3.8 |
| Ex. | 2 | 0.46 | 0.11 | 82.2 | 92.8 | 4.2 | 0.1 | — | 2.9 | 173 | 1.59 | 30.8 | 2.9 |
| | 3 | 0.14 | 0.39 | 70.2 | 94.9 | — | — | — | 5.1 | 191 | 6.84 | 63.2 | 6.3 |
| | 4 | 1.40 | 0.45 | 79.6 | 98.6 | — | — | 0.8 | 0.6 | 208 | 0.48 | 32.2 | 5.7 |

As can be seen from Table 2, it was demonstrated that the soft magnetic metal powder of the present invention is a collection of fine particles having a high spheroidization ratio and a narrow particle size distribution, has high saturation magnetization, and can be used to prepare a paste having low viscosity from which a thin layer can be easily formed, and the resulting thin layer has excellent surface smoothness.

### INDUSTRIAL APPLICABILITY

The soft magnetic metal powder of the present invention is a soft magnetic metal powder that is a collection of fine particles, that has a high spheroidization ratio and can thus be used to prepare a paste having low viscosity, that has a low content of boron, which decreases saturation magnetization, and can thus be used to fabricate an electronic component having excellent magnetic characteristics, and that has a narrow particle size distribution and thus has high dispersibility in solvent and can be used to form a thin layer having excellent surface smoothness.

Accordingly, the present invention is an invention having high industrial applicability.

1. A soft magnetic metal powder having an average particle size of 0.05 μm or more and 1.5 μm or less, a coefficient of variation expressed by the following (expression 1) of 0.25 or less, a boron content of less than 1.5% by weight (excluding 0), and a spheroidization ratio expressed by the following (expression 2) of 75% or more:
standard deviation of particle size/average particle size (expression 1)
(area/area of smallest circumcircle)×100 (expression 2)

2. The soft magnetic metal powder according to claim 1, wherein the soft magnetic metal powder has an oxygen content of 3.0% by weight or less.

3. The soft magnetic metal powder according to claim 1, wherein the soft magnetic metal powder has an iron content of 93% by weight or more.

4. The soft magnetic metal powder according to claim 1, wherein the soft magnetic metal powder is coated with one or more metal oxides.

5. The soft magnetic metal powder according to claim 4, wherein metal elements of the metal oxides are each aluminum, silicon, zirconium, titanium, yttrium, or phosphorus.

6. A method for manufacturing the soft magnetic metal powder according to claim 1, comprising:
subjecting to spheroidization treatment a soft magnetic metal powder manufactured by a liquid-phase reduction method in which a reductant containing a boron-based reductant is added dropwise to a metal salt aqueous solution containing a metal salt, a complexing agent, a pH adjuster, and a phosphorus-based reductant.

7. The method for manufacturing the soft magnetic metal powder according to claim 1, wherein the soft magnetic metal powder is spheroidized by mechanochemical treatment.
